(19) United States
(12) Patent Application Publication
(10) Pub. No.: US 2019/0087602 A1
(43) Pub. Date: Mar. 21, 2019

(54) OFFLINE DOCUMENT DE-IDENTIFICATION APPARATUS AND METHOD, AND OFFLINE DOCUMENT RESTORATION APPARATUS

(71) Applicant: ELECTRONICS AND TELECOMMUNICATIONS RESEARCH INSTITUTE, Daejeon (KR)

(72) Inventors: So Hee PARK, Daejeon (KR); Geonwoo KIM, Daejeon (KR)

(73) Assignee: ELECTRONICS AND TELECOMMUNICATIONS RESEARCH INSTITUTE, Daejeon (KR)

(21) Appl. No.: 16/116,901

(22) Filed: Aug. 29, 2018

(30) Foreign Application Priority Data
Sep. 19, 2017 (KR) 10-2017-0120702
Jul. 20, 2018 (KR) 10-2018-0085029

(51) Int. Cl. G06F 21/62; H04N 1/40; G06F 17/21; G06F 17/24; G06F 3/12

(52) U.S. Cl. CPC G06F 21/6245; H04N 1/40093; G06F 17/212; H04L 2209/16; G06F 3/1222; G06F 3/1238; G06F 3/1284; G06F 17/24

(57) ABSTRACT

An offline document de-identification apparatus and method, and an offline document restoration apparatus, are disclosed. The offline document de-identification apparatus may include an image obtainer acquiring offline document as an image, a document area detector detecting a document area in the acquired image, a de-identifier performing de-identification on a first area which is an area including the personal information in the document area, and a printer outputting document including the de-identified first area.

### CROSS-REFERENCE TO RELATED APPLICATION

This application claims priority to and the benefit of Korean Patent Application No. 10-2017-0120702 and 10-2018-0085029 filed in the Korean Intellectual Property Office on Sep. 19, 2017 and Jul. 20, 2018, respectively, the entire contents of which are incorporated herein by reference.

### BACKGROUND OF THE INVENTION

### (a) Field of the Invention

The present invention relates to an offline document de-identification apparatus and method, and an offline document restoration apparatus.

### (b) Description of the Related Art

Documents containing personal identification information (for example, copies of ID cards, mailing addresses, group membership applications, etc.) are being circulated without security. As a result, personal identity information is exposed and this becomes a social problem. In order to improve this, some of the areas containing the personal identification information in the document were covered or converted into other contents and circulated. However, since the personal information is permanently deleted, there is a problem that the personal identification information cannot be confirmed again as needed.

Personal identification information circulated online or offline is de-identified in various ways and distributed in order to protect individual privacy. Personal identification information should be concealed by an unspecified number of people in order to protect individual privacy, but for social safety services, it should be possible to restore it by an authorized administrator if necessary. Personal identification information online can be applied to technologies that can be de-identified and restored through privacy masking techniques. However, there is no provision for de-identifiable technology that can restore personal identification information offline.

### SUMMARY OF THE INVENTION

The present invention has been made in an effort to provide an apparatus and a method for de-identifying an area including personal identification information in an offline document and restoring it if necessary.

According to an exemplary embodiment of the present invention, an offline document de-identification apparatus is provided. The offline document de-identification apparatus may include an image obtainer acquiring an offline document as an image, a document area detector detecting a document area in the acquired image, a de-identifier performing de-identification on a first area which is an area including personal information in the document area, and a printer outputting a document including the de-identified first area.

The de-identifier may perform de-identification on the first area through masking.

The de-identifier unit may insert a marker for indicating the de-identified first area in the document area.

The de-identifier may store image information corresponding to the inserted marker at a predetermined position in the document area.

The image obtainer may be a scanner of a camera of a smart phone.

The document area detector may correct distortion caused by a perspective transformation in the acquired image and perform scale correction on a document with a predetermined size.

According to another exemplary embodiment of the present invention, an offline document restoration apparatus is provided. The offline document restoration apparatus may include an image obtainer acquiring a first document, which is a document in which a first region including personal information is de-identified, as an image, a document area detector detecting a document area in the image of the first document, a masking area detector detecting a masking area in the detected document area, and an image restorer performing unmasking on the masking area.

A marker for indicating the masking area may be inserted in the document area, and the masking area detector may detect the masking area using the marker.

The document area may include image information corresponding to a first area in which the marker is inserted, and the image restorer may restore an original image of the first area using the image information.

The image obtainer may be a scanner of a camera of a smart phone.

The document area detector may correct distortion caused by a perspective transformation in the image of the first document, and perform scale correction on a document with a predetermined size.

The offline document restoration apparatus may further include a printer outputting an image restored by the image restorer.

According to another exemplary embodiment of the present invention, a method of de-identifying an offline document by an offline document de-identification apparatus is provided. The method may include obtaining the offline document as an image, detecting a document area in the acquired image, performing de-identification on a predetermined first area of the document area, and outputting a document including the de-identified first area.

The first area may be an area including personal information.

The performing de-identification includes performing masking on the first area, and inserting a marker indicating the masked area.

The performing de-identification may further include storing image information corresponding to the inserted marker at a predetermined position in the document area.

The detecting may include correcting distortion caused by a perspective transformation in the acquired image and performing scale correction on a document with a predetermined size.

According to an exemplary embodiment of the present invention, it is possible to protect personal privacy by de-identifying an area including personal identification information in an offline document.

According to an exemplary embodiment of the present invention, de-identified areas can be restored to handle personal information in de-identified offline documents.

### BRIEF DESCRIPTION OF THE DRAWINGS

FIG. 1 is a block diagram showing an offline document de-identification apparatus according to an exemplary embodiment of the present invention.

FIG. 2 is a diagram showing an area in which de-identification (non-discrimination) is required in the corrected document area according to an exemplary embodiment of the present invention.

FIG. 3 is a diagram showing a masking area according to an exemplary embodiment of the present invention.

FIG. 4 is a diagram showing a marker inserted in a masking area according to an exemplary embodiment of the present invention.

FIG. 5 is a diagram showing a position where original image information of a marker according to an embodiment of the present invention is stored.

FIG. 6 is a flowchart showing a method for de-identifying an offline document according to an exemplary embodiment of the present invention.

FIG. 7 is a block diagram showing an offline document restoration apparatus according to an exemplary embodiment of the present invention.

FIG. 8 is a diagram showing a method for detecting the masked area according to an exemplary embodiment of the present invention.

FIG. 9 is a diagram showing a method of restoring an image in which a marker is displayed according to an exemplary embodiment of the present invention.

FIG. 10 is a diagram showing a method for restoring an offline document according to an exemplary embodiment of the present invention.

FIG. 11 is a diagram showing a computer system according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising” will be understood to imply the inclusion of stated elements but not the exclusion of any other elements.

The offline document de-identification apparatus according to an exemplary embodiment of the present invention may acquire an offline document including personal identification information as an image, and automatically or manually select an area requiring de-identification (masking) from the user. The offline document de-identification apparatus may mask the selected area through various masking programs and print the masked document as a de-identified offline document. Such de-identified offline document is freely distributed offline.

The offline document restoration apparatus according to an exemplary embodiment of the present invention may obtain the de-identified offline document as an image when necessary. The offline document restoration apparatus may detect a masked area in the de-identified offline document and restore (unmask) the detected masking area as the original image. This allows personal identification information to be verified. Meanwhile, secret information such as an encryption key in a masking or unmasking process can be shared among users, thereby preventing an unauthorized user from masking or unmasking.

Hereinafter, an offline document de-identification apparatus and an offline document restoration apparatus according to an exemplary embodiment of the present invention will be described in detail.

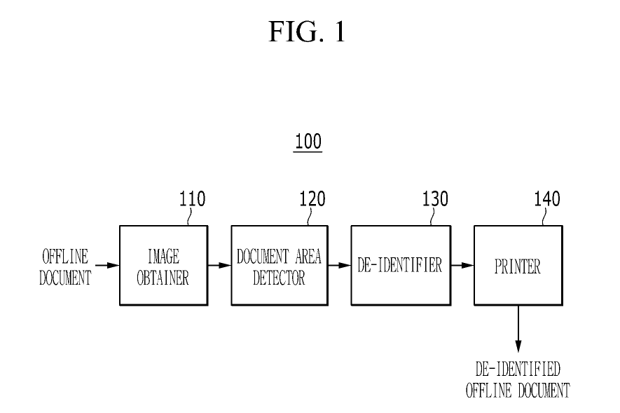

FIG. 1 is a block diagram showing an offline document de-identification apparatus 100 according to an exemplary embodiment of the present invention.

As shown in FIG. 1, the offline document de-identification apparatus 100 according to an exemplary embodiment of the present invention includes an image obtainer 110, a document area detector 120, a de-identifier 130, and a printer 140.

The image obtainer 110 acquires an offline document including personal identification information as an image. The image obtainer 110 may be a scanner or a camera of a smart phone. That is, an offline document can be acquired as an image through a scanner or a camera of a smart phone, which is an image acquiring device.

The document area detector 120 performs image processing on the image acquired by the image obtainer 110 to detect a document area. The document area detector 120 acquires only the document area in the image acquired by the image obtainer 110. That is, the document area detector 120 detects the document outline in the image and extracts only the document area. Meanwhile, the image acquired through the image obtainer 110 may not be acquired in the form of a rectangle of the original document due to perspective transformation. Accordingly, the document area detector 120 corrects a distortion caused by perspective transformation and scales the entire document to a document of a predetermined size to acquire the document area. Hereinafter, the document area finally detected by the document area detector 120 is referred to as a ‘corrected document area’.

The de-identifier 130 performs de-identification (masking) on an area 131 in which the de-identification is required among the corrected document area inputted from the document area detector 120.

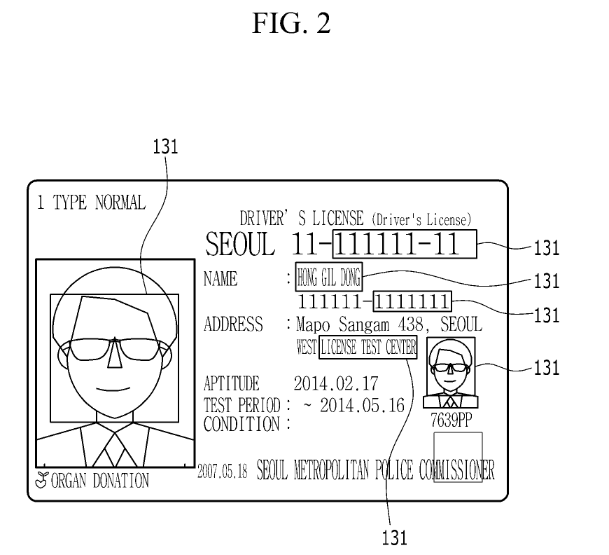

FIG. 2 is a diagram showing an area 131 in which de-identification (non-discrimination) is required in the corrected document area according to an exemplary embodiment of the present invention. As shown in FIG. 2, the area 131 in which the de-identification is required is an area (for example, a face, a name, or the like) that requires confidentiality in a document including personal information. The area 131 where the de-identification (non-discrimination) is required can be automatically or manually selected by the user. In the case of automatically selecting by the user, the user can register a specific document format in advance.

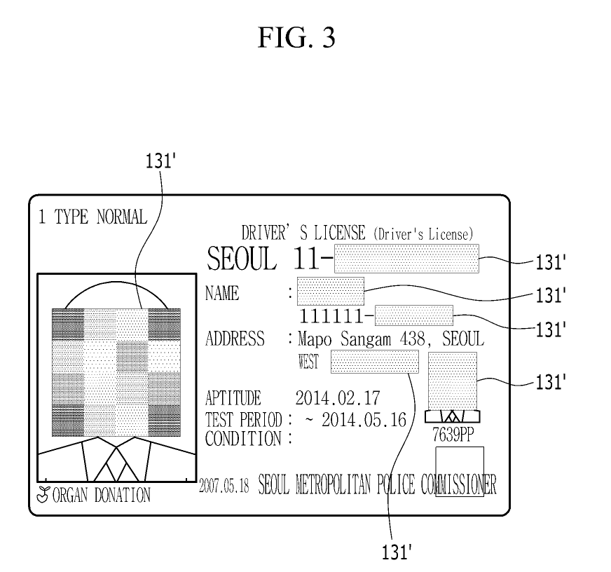

When the de-identification area 131 is selected, the de-identifier 130 performs masking on the selected area 131 through a masking program. Here, various masking programs can be used, and a masking program using a key can be used for security services. The method of performing masking through the masking program may be understood by those skilled in the art, and thus a detailed description thereof is omitted. Hereinafter, the portion masked by the de-identifier 130 in the corrected document area will be referred to as a ‘masking area’. FIG. 3 is a diagram showing a masking area 131′ according to an exemplary embodiment of the present invention. As shown in FIG. 3, the area 131 in which the de-identification is required is masked and de-identified.

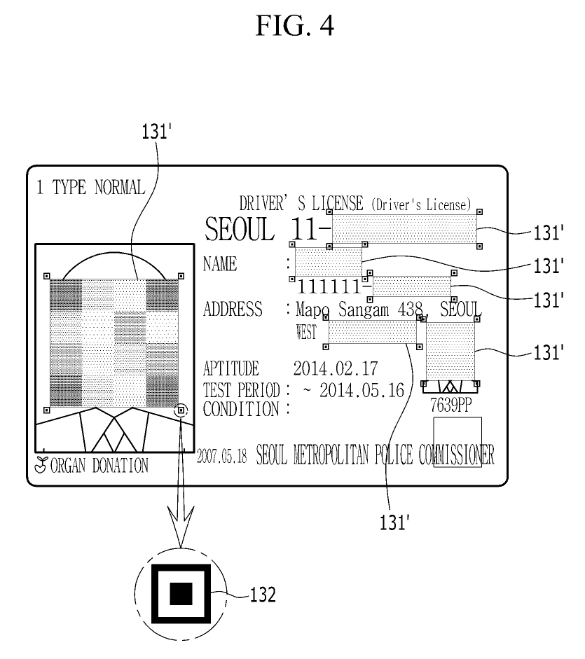

After performing the masking, the de-identifier 130 inserts a marker 132 into the masking area 131 ′. That is, the de-identifier 130 inserts the marker 132 into the masking area so that the masking area can be found at the time of restoration. FIG. 4 is a diagram showing a marker 132 inserted in a masking area according to an exemplary embodiment of the present invention. The markers 132 can be inserted in various ways, and as shown in FIG. 4, a square marker 132 as an example can be inserted into the square corners of each masking area 131 ′.

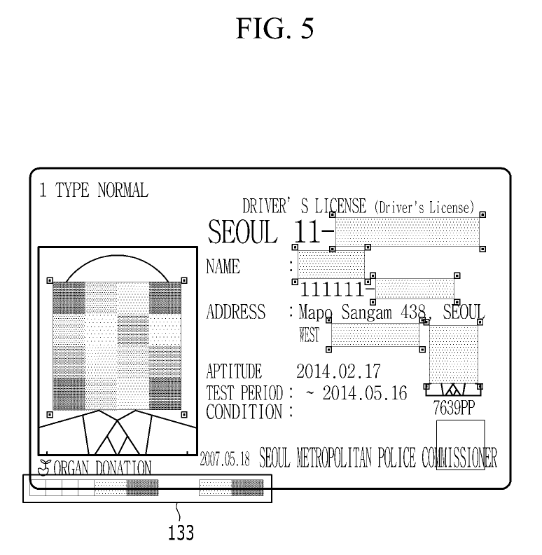

Since the original image information at the position where the marker 132 is inserted may be lost, the de-identifier 130 stores the original image information at the position where the marker 132 is inserted in an area that is not important in the corrected document area (for example, a blank part that does not contain specific information). FIG. 5 is a diagram showing a position 133 where original image information of a marker according to an embodiment of the present invention is stored. As shown in FIG. 5, the de-identifier 130 can store the original image information at the position where the marker 132 is inserted in the lower end 133 of the entire image. The original image information of the marker stored in the lower end 133 of the entire image can be used for restoration later.

The printer 140 outputs the de-identified (non-identified) document generated by the de-identifier 130 to generate the de-identified offline document.

The generated de-identified offline document can prevent the outflow of the personal identification information even if the personal identification information is de-identified and circulated offline.

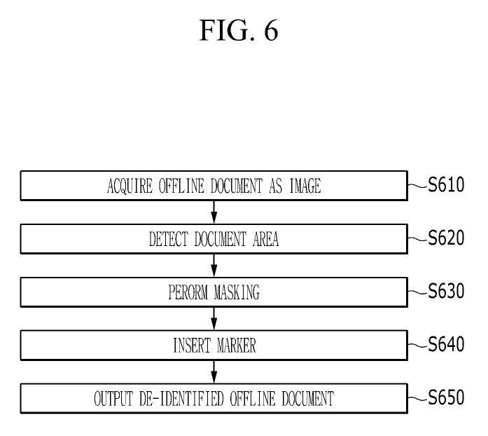

FIG. 6 is a flowchart showing a method for de-identifying an offline document according to an exemplary embodiment of the present invention.

First, the offline document de-identification apparatus 100 acquires an offline document including personal identification information as an image (S610). That is, the image obtainer 110 acquires an offline document including personal identification information as an image through a scanner or a camera of a smart phone.

The offline document de-identification apparatus 100 performs image processing on the image acquired in step S610 to detect a document area (S620). That is, the document area detector 120 detects the document outline in the image obtained in step S610, and extracts only the document area. The document area detector 120 corrects a distortion due to perspective transformation and scales the entire document to a document of a predetermined size to acquire the document area.

In step S630, the offline document de-identification apparatus 100 performs masking on an area in which the de-identification (non-discrimination) is required in the document area (corrected document area) detected in step S620. That is, the de-identifier 130 performs masking on the area 131 requiring de-identification through a masking program. Here, the area 131 requiring de-identification can be automatically or manually selected by a user.

The offline document de-identification apparatus 100 inserts the marker 132 into the masked area generated in step S630 (S640). That is, the de-identifier unit 130 inserts the marker 132 into the masking area 131′ after performing the masking in step S630. Then, the de-identifier unit 130 may store the original image information at the position where the marker 132 is inserted in the non-critical area in the corrected document area.

The offline document de-identifier apparatus 100 outputs or prints the de-identified document in which the marker is inserted (S650). Such de-identified documents can be distributed offline on the basis of the de-identified personal identity information.

Meanwhile, the de-identified offline document outputted by the offline document de-identification apparatus 100 can be restored to the original image by an offline document restoration apparatus 200. Such an offline document restoration apparatus 200 will be described in detail below.

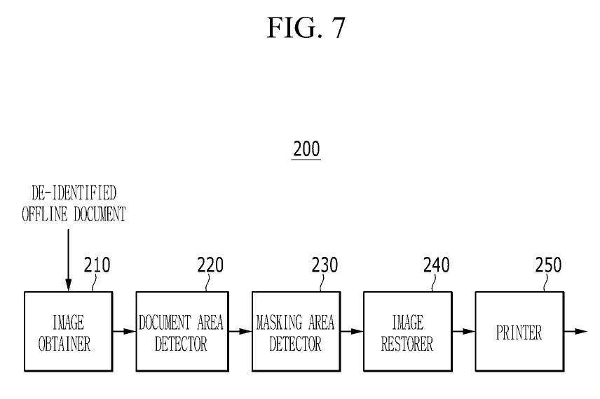

FIG. 7 is a block diagram showing an offline document restoration apparatus 200 according to an exemplary embodiment of the present invention.

As shown in FIG. 7, the offline document restoration apparatus 200 according to an exemplary embodiment of the present invention includes an image obtainer 210, a document area detector 220, a masking area detector 230, an image restorer 240, and a printer 250.

The image obtainer 210 acquires the de-identified offline document as an image. The image obtainer 210 may be a scanner or a camera of a smart phone. That is, the de-identified offline document can be acquired as an image through a scanner or a camera of a smart phone, which is an image acquisition device.

The document area detector 220 performs image processing on the image of the de-identified offline document acquired by the image obtainer 210 to detect a document area. That is, the document area detector 220 detects the document outline in the image of the de-identified offline document, and extracts only the document area. Meanwhile, the image acquired through the image obtainer 210 may not be acquired in the form of a rectangle of the original document due to a perspective transformation. Accordingly, the document area detector 220 corrects the distortion caused by the perspective transformation, and scales an entire document to a document of a predetermined size to acquire the document area. Hereinafter, the document area finally detected by the document area detector 220 is referred to as a ‘corrected de-identified document area’.

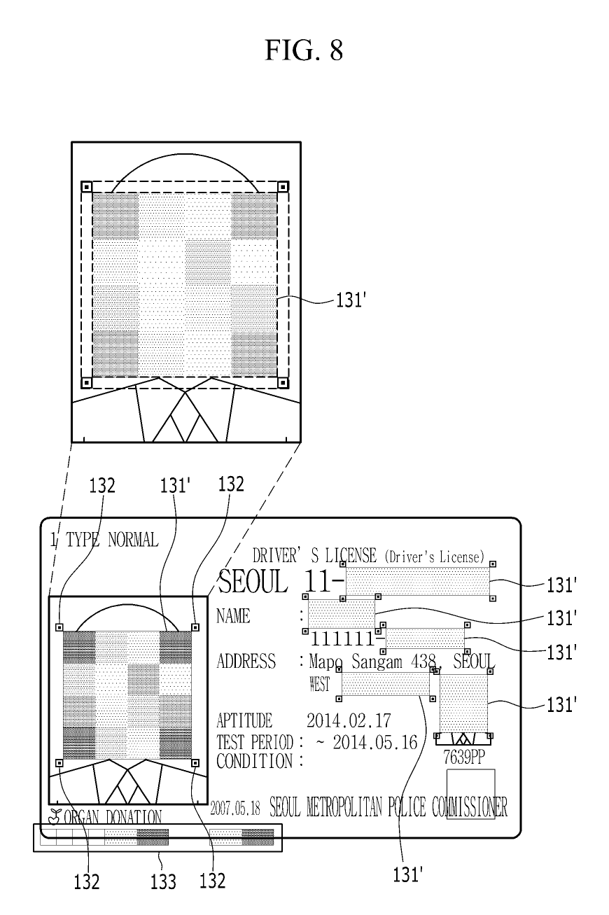

The masking area detector 230 detects the masking area in the corrected de-identified document area acquired by the document area detector 220. FIG. 8 is a diagram showing a method for detecting the masked area according to an exemplary embodiment of the present invention. As shown in FIG. 8, the masking area detector 230 detects the marker 132 in the corrected de-identified document area, and detects a masking area 131′ using the detected marker 132. As described above, the marker 132 is inserted in the de-identified offline document to display the masking area 131′. The masking area detector 230 detects the masking area 131′ by using the inserted marker 132. As an example, when a rectangular marker 132 is inserted in a rectangular corner of each masking area 131′, the masking area detector 230 can detect the masking area 131′ by grouping four markers after detecting the markers.

The image restorer 240 performs unmasking on the masking area 131′ detected by the masking area detector 230 to restore an image. The image restorer 240 restores the image by applying an unmasking program to the masking region 131′. Here, various unmasking programs can be used, and unmasking programs using keys can be used for security services. The method for performing unmasking through the unmasking program may be understood by those skilled in the art, and thus a detailed description thereof is omitted.

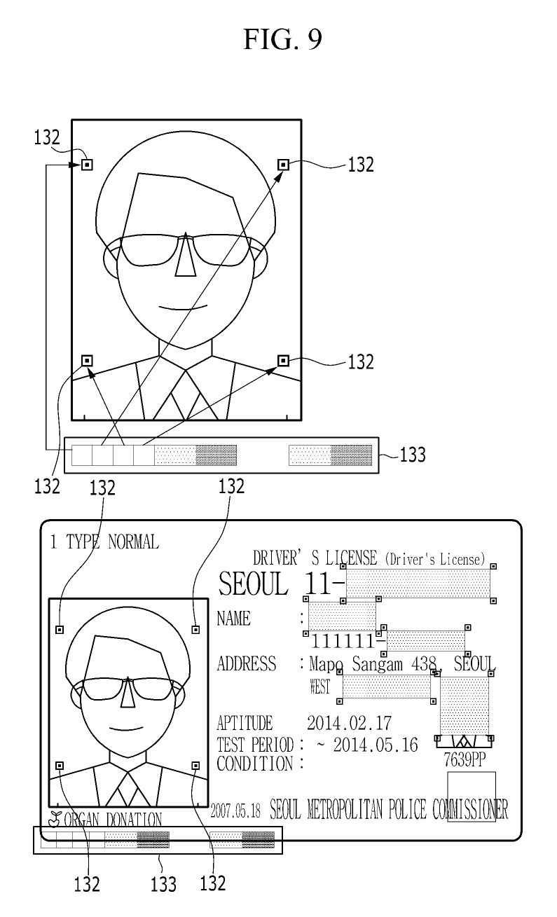

The image unmasked by the image restorer 240 is an original image in which the marker 132 is displayed (inserted). FIG. 9 is a diagram showing a method of restoring an image in which a marker is displayed according to an exemplary embodiment of the present invention. In order to restore a more accurate original image, the image restorer 240 sequentially copies the original image information of the marker stored in the position 133 where the original image information of the marker is stored, to the position of the marker 132, and can thereby restore the original image.

The final image reconstructed (restored) by the image restorer 240 may be confirmed to the user in the image state or may be outputted as an offline document by the printer 250. The printer 250 may output the final original image reconstructed (restored) by the image restorer 240.

As described above, the offline document restoration apparatus 200 according to an exemplary embodiment of the present invention can convert the de-identified offline document into an original image, which includes personal identification information.

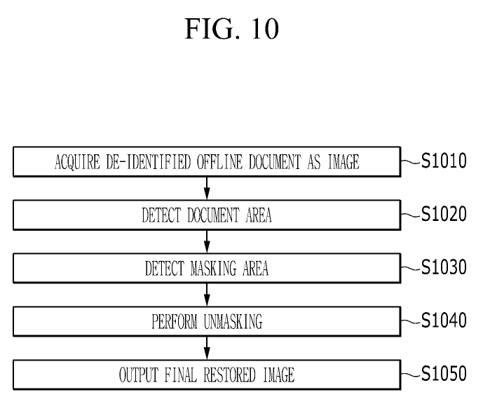

FIG. 10 is a diagram showing a method for restoring an offline document according to an exemplary embodiment of the present invention.

The offline document restoration apparatus 200 acquires the de-identified offline document as an image (S1010). That is, the image obtainer 210 acquires the de-identified offline document as an image through a scanner or a camera of a smart phone.

The offline document restoration apparatus 200 performs image processing on the image of the de-identified offline document obtained in step S1010 to detect the document area (S1020). That is, the document area detector 220 detects the document outline in the image of the de-identified offline document and extracts only the document area. Then, the document area detector 220 corrects the distortion due to the perspective transformation and scales an entire document to a document of a predetermined size to acquire the document area.

The offline document restoration apparatus 200 detects a masked area in the document area detected in step S1020 (S1030). That is, the masking area detector 230 detects the markers 132 in the document area (corrected de-identified document area) detected in step S1020, and detects the masking area 131′ using the detected markers 132.

In step 1040, the offline document restoration apparatus 200 restores the image by unmasking the masking area detected in step S1030. That is, the image restorer 240 restores the image by applying an unmasking program to the masking region 131′. In order to restore a more accurate original image, the image restorer 240 sequentially copies the original image information of the marker stored in the position 133 where the original image information of the marker is stored, to the position of the marker 132, and can thereby restore the original image. The user can confirm the final image acquired in step S1030 in a video state.

Meanwhile, the offline document restoration apparatus 200 may output the final image restored in step S1050 as an offline document (S1050).

As described above, according to the exemplary embodiment of the present invention, the area including the personal identification information included in the offline document can be de-identified, and if necessary, the de-identified part can be restored to the original image.

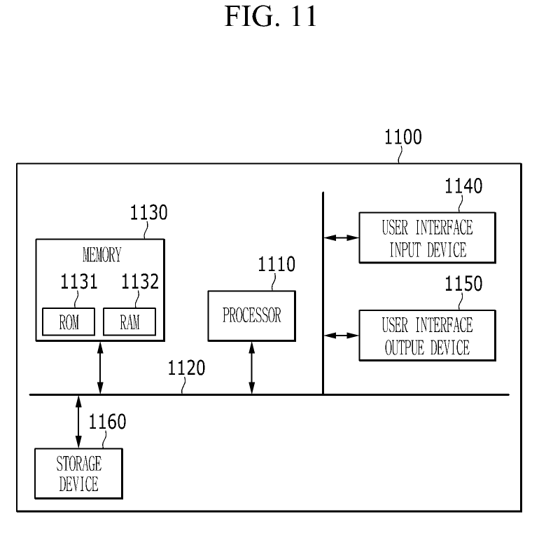

FIG. 11 is a diagram showing a computer system 1100 according to an exemplary embodiment of the present invention.

The offline document de-identification apparatus 100 and the offline document restoration apparatus 200 according to an exemplary embodiment of the present invention may be implemented by the computer system 1100 as shown in FIG. 11. Each component (element) of the offline document non-identification apparatus 100 and each component (element) of the offline document restoration apparatus 200 may be implemented by the computer system 1100 as shown in FIG. 11.

The computer system 1100 includes at least one of a processor 1110, a memory 1130, a user interface input device 1140, a user interface output device 1150, and a storage device 1160 that communicate via a bus 1020.

The processor 1110 may be a central processing unit (CPU) or a semiconductor device that executes instructions stored in the memory 1130 or the storage device 1160. The processor 1110 may be configured to implement the functions and methods described in FIG. 1 to FIG. 10.

The memory 1130 and the storage device 1160 may include various forms of volatile or non-volatile storage media. For example, the memory 1130 may include a read only memory (ROM) 1131 and a random access memory (RAM) 1132. In an exemplary embodiment of the present invention, the memory 1130 may be located inside or outside the processor 1110, and the memory 1130 may be coupled to the processor 1110 through various already known means.

Thus, an exemplary embodiment of the present invention may be embodied through a computer-implemented method or as a non-volatile computer-readable medium having computer-executable instructions stored thereon. In an exemplary embodiment of the present invention, when executed by a processor, the computer-readable instructions may perform a method according to at least one aspect of the present disclosure.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An offline document de-identification apparatus comprising:
an image obtainer acquiring an offline document as an image;
a document area detector detecting a document area in the acquired image;
a de-identifier performing de-identification on a first area which is an area including personal information in the document area; and
a printer outputting a document including the de-identified first area.

2. The offline document de-identification apparatus of claim 1, wherein
the de-identifier performs de-identification on the first area through masking.

3. The offline document de-identification apparatus of claim 1, wherein
the de-identifier unit inserts a marker for indicating the de-identified first area in the document area.

4. The offline document de-identification apparatus of claim 3, wherein
the de-identifier stores image information corresponding to the inserted marker at a predetermined position in the document area.

5. The offline document de-identification apparatus of claim 1, wherein
the image obtainer is a scanner of a camera of smart phone.

6. The offline document de-identification apparatus of claim 1, wherein
the document area detector corrects distortion caused by a perspective transformation in the acquired image and performs scale correction on a document with a predetermined size.

7. An offline document restoration apparatus comprising:
an image obtainer acquiring a first document, which is a document in which a first region including personal information is de-identified, as an image;
a document area detector detecting a document area in the image of the first document;
a masking area detector detecting a masking area in the detected document area; and
an image restorer performing unmasking on the masking area.

8. The offline document restoration apparatus of claim 7, wherein
a marker for indicating the masking area is inserted in the document area, and
the masking area detector detects the masking area using the marker.

9. The offline document restoration apparatus of claim 8, wherein
the document area includes image information corresponding to a first area in which the marker is inserted, and
the image restorer restores an original image of the first area using the image information.

10. The offline document restoration apparatus of claim 7, wherein
the image obtainer is a scanner of a camera of a smart phone.

11. The offline document restoration apparatus of claim 7, wherein
the document area detector corrects distortion caused by a perspective transformation in the image of the first document, and performs scale correction on a document with a predetermined size.

12. The offline document restoration apparatus of claim 7, further comprising
a printer outputting an image restored by the image restorer.

13. A method of de-identifying an offline document by an offline document de-identification apparatus, the method comprising:
obtaining the offline document as an image;
detecting a document area in the acquired image;
performing de-identification on a predetermined first area of the document area; and
outputting a document including the de-identified first area.

14. The method of claim 13, wherein
the first area is an area including personal information.

15. The method of claim 13, wherein
the performing de-identification comprises:
performing masking on the first area, and
inserting a marker indicating the masked area.

16. The method of claim 15, wherein
the performing de-identification further comprises storing image information corresponding to the inserted marker at a predetermined position in the document area

17. The method of claim 13, wherein
the detecting comprises correcting distortion caused by a perspective transformation in the acquired image and performing scale correction on a document with a predetermined size.
